(19) United States
(12) Patent Application Publication
(10) Pub. No.: US 2024/0142375 A1
(43) Pub. Date: May 2, 2024

(54) SAMPLE OBSERVATION DEVICE AND SAMPLE OBSERVATION METHOD

(71) Applicant: HAMAMATSU PHOTONICS K.K., Hamamatsu-shi, Shizuoka (JP)

(72) Inventors: Kyohei SHIGEMATSU, Hamamatsu-shi, Shizuoka (JP); Koji TAKAHASHI, Hamamatsu-shi, Shizuoka (JP); Takashi INOUE, Hamamatsu-shi, Shizuoka (JP)

(73) Assignee: HAMAMATSU PHOTONICS K.K., Hamamatsu-shi, Shizuoka (JP)

(21) Appl. No.: 18/279,080

(22) PCT Filed: Dec. 15, 2021
(86) PCT No.: PCT/JP2021/046306

§ 371 Date: Aug. 28, 2023

(30) Foreign Application Priority Data
Apr. 20, 2021 (JP) 2021-070905

(51) Int. Cl. G01N 21/64; G01N 21/17; G01N 21/25

(52) U.S. Cl. CPC G01N 21/6408; G01N 21/255; G01N 21/6458; G01N 2021/1757; G01N 2021/1789; G01N 2021/6423; G01N 21/648; G01N 2201/0696

(57) ABSTRACT

A sample observation device includes a light source unit configured to output a pulse train in which multiple optical pulses with different center wavelengths are arranged at predetermined time intervals as excitation light; a measurement unit configured to perform time-resolved measurement on an optical response that is transmitted from the sample and corresponds to irradiation with the optical pulses included in the pulse train while scanning the sample with the excitation light, and to acquire measurement data with respect to the optical pulses; and a processing unit configured to perform linear unmixing processing on the measurement data with respect to the optical pulses on the basis of an excitation spectrum for every target included in the sample.

### TECHNICAL FIELD

The present disclosure relates to a sample observation device and a sample observation method.

### BACKGROUND ART

As a sample observation device in the related art, for example, a fluorescence microscope is exemplified. In the fluorescence microscope, a fluorescent dye that selectively chemically bonds to a target in the sample is injected, and fluorescence emitted from the target due to irradiation with excitation light is observed. However, in the fluorescence microscope, in a case where the sample is a living organism, it is necessary to consider invasiveness. For example, it is necessary to give sufficient consideration to safety of a fluorescent dye to a living organism, or handling of excitation light in a visible region having relatively high energy.

In recent years, instead of the fluorescence observation in the related art, a nonlinear optical microscope based on a phenomenon such as multiphoton excited fluorescence and harmonic generation attracted attention. In the nonlinear optical microscope, for example, near infrared pulses with a wavelength of approximately 700 nm to 1700 nm is used. The near infrared pulses has lower photon energy in comparison to visible light, and thus invasiveness in the nonlinear optical microscope is relatively low. In addition, the multiphoton excited fluorescence and harmonic generation may occur without staining. From the viewpoint in which staining of the sample is not required, it can be said that invasiveness of the nonlinear optical microscope is low. A microscope having a function capable of identifying different targets by identifying optical response based on different observation modalities such as multiphoton excited fluorescence and harmonic generation is referred to as a multimodal microscope.

Examples of a technology relating to the nonlinear optical microscope include methods described in Non-Patent Literature 1 and Non-Patent Literature 2. In Non-Patent Literature 1, imaging is performed while changing the wavelength for exciting a sample, a portion where only a single target emits light is extracted from an image of the sample, and separation processing is performed on the basis of an excitation spectrum of the extracted portion. In Non-Patent Literature 2, polarization of light emitted to a sample is modulated for every pulse, and an orientation direction of collagen in the tail of a mouse is observed.

### CITATION LIST

### Non Patent Literature

Non Patent Literature 1: Andrew J. Radosevich et al., “Hyperspectral in-vivo two-photon microscopy of intrinsic fluorophores” Biomedical Optics 2008, OSA Technical Digest (CD) paper BWG7.pdf
Non Patent Literature 2: Ximeng Y. Dow et al., “Imaging the Nonlinear Susceptibility Tensor of Collagen by Nonlinear Optical Stokes Ellipsometry” Biophysical Journal 111, 1361-1374, Oct. 4, 2016

### SUMMARY OF INVENTION

### Technical Problem

In the multimodal observation, a major premise is to use ultrashort optical pulses rather than typical laser light so that several photons are simultaneously absorbed by the target. In recent years, development of a light source that generates the ultrashort optical pulses is in progress. On the other hand, in realizing the multimodal observation, non-use of target staining makes the system construction difficult.

Specifically, in the typical multimodal observation, since the multiple optical pulses with different wavelengths are required for the excitations of the multiple modalities, it is necessary to incorporate several light sources corresponding to the number of the observation modalities into the microscopic system. In addition, in order to identify each of the optical responses from the sample, it is necessary to incorporate multiple wavelength separation elements such as dichroic mirrors and photodetectors into the microscopic system in accordance with the number of observation modalities. When considering that users of the microscopic system are not always laser specialists, the typical system for multimodal microscopy has a complicated optical system and is difficult to handle for the users.

In addition, issues for realizing multimodal observation with a simple configuration also exists. For example, in a case of performing the multimodal observation with a single ultrashort pulse laser, it is necessary to switch wavelengths for each modality. When switching the wavelengths, since a finite time lag occurs, fast observation of a sample based on the switching of the wavelengths is difficult. As another approach, it is considered that all modalities are simultaneously excited by setting the excitation wavelength near an average of appropriate wavelengths for each of the modalities. However, in the method, since the excitation wavelength is not appropriate for each of the modalities, the pulse energy of the excitation pulse must be increased in order to perform observation with a satisfactory S/N ratio, and as a result, invasiveness of the sample is increased.

The present disclosure has been made to solve the above-described issues, and an object thereof is to provide a sample observation method and a sample observation device capable of performing multimodal observation of a sample with a simple optical system.

### Solution to Problem

According to an aspect of the present disclosure, there is provided a sample observation device including: a light source unit configured to output a pulse train in which multiple optical pulses with different center wavelengths are arranged at predetermined time intervals as excitation light; a measurement unit configured to perform time-resolved measurement on an optical response that is transmitted from the sample and corresponds to irradiation with the optical pulses included in the pulse train while scanning the sample with the excitation light, and to acquire measurement data with respect to the optical pulses; and a processing unit configured to perform linear unmixing processing on the measurement data with respect to the optical pulses on the basis of an excitation spectrum for every target included in the sample.

In the sample observation device, the pulse train in which the multiple optical pulses with different center wavelengths are arranged with the predetermined time intervals is formed. Each of the center wavelengths of the multiple optical pulses is applied to each observation modality, and thus it is not necessary to incorporate multiple laser sources corresponding to the number of observation modalities. In addition, in the sample observation device, the time-resolved measurement is performed on the optical response that is transmitted from the sample and corresponds to irradiation with the optical pulses, and the linear unmixing processing is performed on the measurement data on the basis of the excitation spectrum for every target included in the sample. According to this, it is not necessary to arrange multiple wavelength separation elements and photodetectors which correspond to the number of the observation modalities. In addition, since the linear unmixing processing is used, the cross-talks between obtained images associated with the individual targets can be avoided in principle. Accordingly, in the sample observation device, multi-modal observation can be performed on a sample with a simple optical system.

The light source unit may generate the pulse train by temporally modulating the center wavelengths of the optical pulses generated from a single light source. According to this, the optical system can be further simplified.

The light source unit may generate the pulse train by using soliton self-frequency shift in which an output wavelength depends on an input intensity. In this case, for example, it is possible to simply perform time modulation for every wavelength of the optical pulses by using a fiber laser. Accordingly, simplification of the device is accomplished.

The processing unit may retain an excitation spectrum of a region in the sample where only a specific target emits light with respect to the multiple optical pulses included in the pulse train in advance, and may perform linear unmixing processing on measurement data with respect to the optical pulses on the basis of the excitation spectrum. In this case, since the excitation spectrum is exactly same as that of the actual sample, the accuracy of the linear unmixing processing can be sufficiently secured. Accordingly, the cross-talks between the targets can be avoided.

The sample observation device may further include an image generation unit configured to generate an observation image relating to a specific target on the basis of the measurement data on which the linear unmixing processing has been performed. According to this, an observed image associated with each of the targets can be obtained in a state in which cross-talks are suppressed.

The image generation unit may generate a superimposed image in which observation images relating to the specific target are superimposed on each other. In this case, observation results relating to respective targets are collected to one image, and thus convenience when analyzing the observation results can be improved. In addition, it is also possible to analyze the events based on the simultaneous observation of multiple modalities.

The measurement unit may include a multi-channel detection unit configured to perform time-resolved measurement on light from the sample. According to this configuration, even in a case where the number of the excitation wavelengths in the pulse train is smaller than the number of targets of the sample, the multi-modal observation can be performed on the sample.

According to another aspect of the present disclosure, there is provided a sample observation method including: an output step of outputting a pulse train in which multiple optical pulses with different center wavelengths are arranged at predetermined time intervals as excitation light; a measurement step of performing time-resolved measurement on an optical response that is transmitted from the sample and corresponds to irradiation with the optical pulses included in the pulse train while scanning the sample with the excitation light, and acquiring measurement data with respect to the optical pulses; and a processing step of performing linear unmixing processing on the measurement data with respect to the optical pulses on the basis of an excitation spectrum for every target included in the sample.

In the sample observation method, the pulse train in which the multiple optical pulses with different center wavelengths are arranged with the predetermined time intervals is formed. Each of the center wavelengths of the multiple optical pulses is applied to each observation modality, and thus it is not necessary to incorporate multiple laser sources corresponding to the number of observation modalities. In addition, in the sample observation method, the time-resolved measurement is performed on the optical response that is transmitted from the sample and corresponds to irradiation with the optical pulses, and the linear unmixing processing is performed on the measurement data on the basis of the excitation spectrum for every target included in the sample. According to this, it is not necessary to arrange multiple wavelength separation elements and photodetectors which correspond to the number of the observation modalities. In addition, since the linear unmixing processing is used, the cross-talks between obtained images associated with the individual targets can be avoided in principle. Accordingly, in the sample observation method, multi-modal observation can be performed on a sample with a simple optical system.

In the output step, the pulse train may be generated by temporally modulating the center wavelengths of the optical pulses generated from a single light source. According to this, the optical system can be further simplified.

In the output step, the pulse train may be generated by using soliton self-frequency shift in which an output wavelength depends on an input intensity. In this case, for example, it is possible to simply perform time modulation for every wavelength of the optical pulses by using a fiber laser.

In the processing step, an excitation spectrum of a region in the sample where only a specific target emits light with respect to the multiple optical pulses included in the pulse train may be retained in advance, and linear unmixing processing may be performed on measurement data with respect to the optical pulses on the basis of the excitation spectrum. In this case, since the excitation spectrum is exactly same as that of actual sample, the accuracy of the linear unmixing processing can be sufficiently secured. Accordingly, the cross-talks between the targets can be avoided.

The sample observation method may further include an image generation step of generating an observation image relating to a specific target on the basis of the measurement data on which the linear unmixing processing has been performed. According to this, an observed image associated with each of the targets can be obtained in a state in which cross-talks are suppressed

In the image generation step, a superimposed image in which observation images relating to the specific target are superimposed on each other may be generated. In this case, observation results relating to respective targets are collected to one image, and thus convenience when analyzing the observation results can be improved. In addition, it is also possible to analyze the events based on the simultaneous observation of multiple modalities.

In the measurement step, time-resolved measurement may be performed on the optical response from the sample by multi-channel detection. According to this configuration, even in a case where the number of the excitation wavelengths in the pulse train is smaller than the number of targets of the sample, the multi-modal observation can be performed on the sample.

### Advantageous Effects of Invention

According to the present disclosure, multimodal observation of a sample can be performed with a simple optical system.

### BRIEF DESCRIPTION OF DRAWINGS

FIG. 1 is a schematic diagram illustrating an embodiment of a sample observation device.

FIG. 2 is a schematic diagram illustrating an example of time modulation of optical pulses with a modulation unit.

FIG. 3 is a timing chart of optical response acquisition in a typical microscope system.

FIG. 4 is a timing chart of optical response acquisition in this embodiment.

FIG. 5 is a diagram illustrating an example of an excitation spectrum.

FIG. 6 is a diagram illustrating an example of a simultaneous equation that is used in linear unmixing processing.

FIG. 7(a) is a diagram illustrating an observation image for each of optical pulses, and FIG. 7(b) is a diagram illustrating a superimposed image of the observation image.

FIG. 8 is a flowchart illustrating an embodiment of a sample observation method.

FIG. 9 is a schematic diagram illustrating a main part of a modification example of the sample observation device.

FIG. 10 is a diagram illustrating an example of an excitation spectrum and a light-emitting spectrum.

FIG. 11 is a diagram illustrating an example of a simultaneous equation that is used in linear unmixing processing.

### DESCRIPTION OF EMBODIMENTS

Hereinafter, preferred embodiments of a sample observation device and a sample observation method relating to an aspect of the present disclosure will be described in detail with reference to the accompanying drawings.

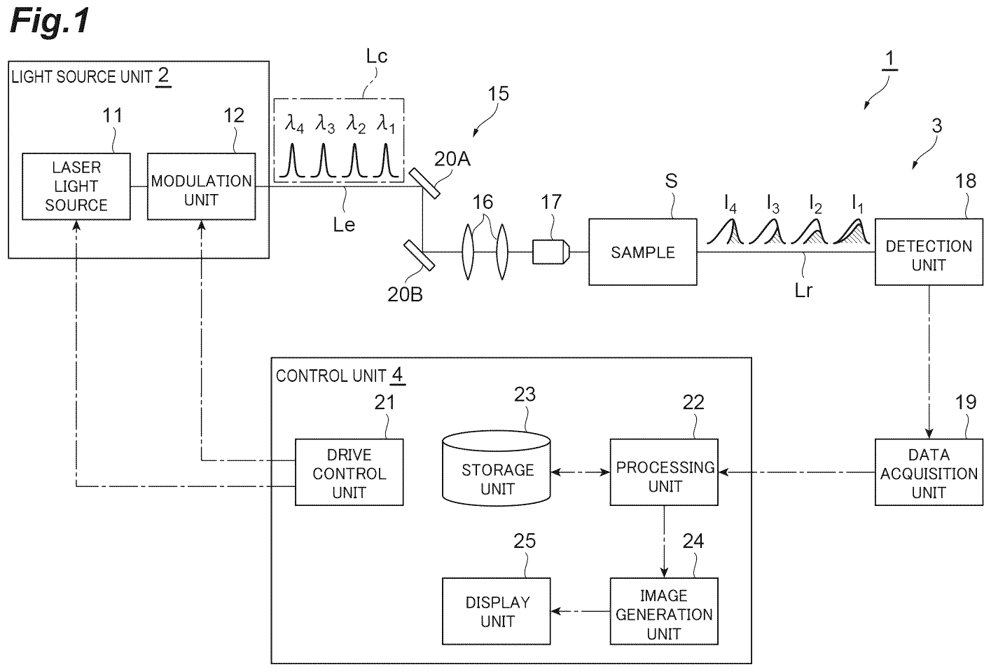

FIG. 1 is a schematic diagram illustrating an embodiment of the sample observation device. A sample observation device 1 is configured as a device that realizes multimodal observation of a sample S. The sample observation device 1 alone may constitute a microscope system, or the sample observation device 1 may be unitized to be attachable to an existing microscope.

The multimodal observation is an observation method in which different observation modalities are combined. In the multimodal observation, for example, near infrared pulses with the wavelength of approximately 700 nm to 1700 nm are used. When combining phenomena such as multiphoton excited fluorescence and generations of harmonic generation with near infrared pulses, observation can be performed without performing staining of the sample S. In multimodal observation, use of dyes for causing fluorescence to be generated can be excluded. In addition, near infrared pulses having relatively low photon energy can be used. According to this, particularly, in a case where the sample S is a living organism, non-invasiveness can be secured.

The multiphoton excited fluorescence is a method of exciting a target in the sample S to a high energy state by multiple photons to emit fluorescence. In the multiphoton excited fluorescence, types such as two-photon excited fluorescence or three-photon excited fluorescence exist. For example, the types are applicable to observation of autofluorescence of the sample S. Examples of a representative target of the autofluorescence include proteins such as keratin and FAD, lipids such as vitamin A, and enzymes such as NAD(P)H.

The harmonic generation is the method of converting multiple photons into one photon under certain conditions to emit light without being accompanied with actual excitation as in the multiphoton excited fluorescence. In the method, the optical response with a wavelength different from the wavelength of the incident pulse is generated from a target due to an operation of the incident light. For example, the second harmonic generation is applicable to observation of microstructures. Examples of a representative target of the second harmonic generation include proteins such as collagen, nucleic acids such as DNA, and lipids such as cholesterol. For example, the third harmonic generation is applicable to observation of an interface between layers with different refractive indices. Examples of a representative target of the third harmonic include proteins such as blood cells, mitochondria, and inorganic substances such as enamel.

Hereinafter, a specific configuration of the sample observation device 1 will be described. As illustrated in FIG. 1, the sample observation device 1 includes a light source unit 2, a measurement unit 3, and a control unit 4. The light source unit 2 includes a laser light source 11 and a modulation unit 12. The laser light source 11 is a light source that emits near infrared ultrashort optical pulses in the femtosecond or picosecond region. For example, the laser light source 11 is a titanium sapphire laser, a Yb:YAG laser, a Yb fiber laser, an Er fiber laser, a Tin fiber laser, or the like.

The modulation unit 12 is a part of temporally modulating center wavelengths of the optical pulses L from a single laser light source 11. The modulation unit 12 outputs a pulse train Lc in which multiple optical pulses L with different center wavelengths are arranged at predetermined time intervals as excitation light Le. In the example illustrated in FIG. 1, the pulse train Lc in which the four optical pulses L with the center wavelengths of λ₁, λ₂, λ₃, and λ₄ are arranged at predetermined time intervals is generated. Light including the pulse train Lc is output from the modulation unit 12 as the excitation light Le.

For example, the modulation unit 12 may be configured to generate the pulse train Lc by using soliton self-frequency shift in which the output wavelength depends on an input intensity. In this case, the modulation unit 12 can be constituted, for example, by a combination of an acousto-optic modulator and a photonic crystal fiber. In this configuration, the soliton self-frequency shift can be caused to occur by causing the pulse train Lc whose intensity is modulated at a high speed by the acousto-optic modulator to propagate through the photonic crystal fiber. The modulation unit 12 may be constituted by a combination of a pulse shaper and a photonic crystal fiber. In this case, the soliton self-frequency shift can be caused by multi-pulses whose intensity is modulated by a pulse shaper to propagate through the photonic crystal fiber.

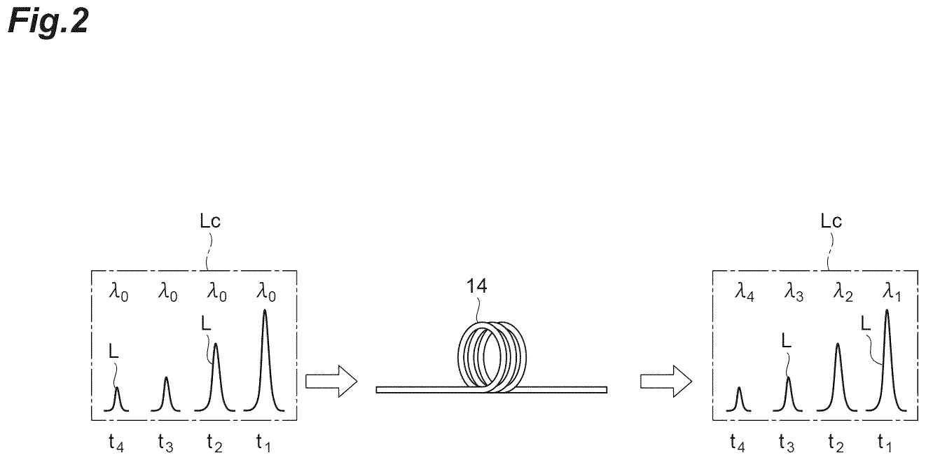

In an example illustrated in FIG. 2, the four optical pulses L with the wavelength of λ₀ are modulated to have four different intensities by an acousto-optic modulator. According to this, the pulse train Lc in which the four optical pulses L are sequentially arranged at times t₁, t₂, t₃, and t₄ is generated. In the pulse train Lc after modulation, the intensity gradually decreases in the order from the optical pulses L earlier in time. The soliton self-frequency shift occurs when these optical pulses L propagate through the photonic crystal fiber 14. In the pulse train Lc output from the photonic crystal fiber 14, the four optical pulses L with central wavelength of λ₁, λ₂, λ₃, and λ₄ are sequentially arranged at times t₁, t₂, t₃, and t₄.

The measurement unit 3 includes a scanning unit 15, a collimator lens 16, an objective lens 17, a detection unit 18, and a data acquisition unit 19. The scanning unit 15 is a part configured to two-dimensionally scan the sample S with the excitation light Le thereon. For example, the scanning unit 15 is constituted by a pair of Galvano-mirrors 20A and 20B. The Galvano-mirror 20A scans the sample S with the excitation light Le in an x-direction, and the Galvano-mirror 20B scans the sample S with the excitation light Le in a y-direction. An element that constitutes the scanning unit 15 is not limited to the Galvano-mirrors, and may be another element such as MEMS mirrors. The scanning unit 15 may also be constituted by other means such as an acousto-optic deflector or an xy stage.

The excitation light Le passed through the scanning unit 15 is collimated by the collimator lens 16, and is focused to the sample S with the objective lens 17. The fluorescence and harmonics (hereinafter, referred to as “optical response Lr”) excited by the optical pulses L included in the pulse train that is the excitation light Le is emitted from the sample S. In the example illustrated in FIG. 1, the four optical responses I₁, I₂, I₃, and I₄ are emitted by the irradiation with the four optical pulses L. It is preferable that a filter (not illustrated) that cuts the excitation light Le and allows the optical response Lr to pass is placed on an optical path between the sample S and the detection unit 18.

The detection unit 18 is the part configured to perform time-resolved measurement for distinguishing the optical responses to the optical pulses L with the different center wavelength included in the pulse train. For example, the detection unit 18 is constituted by a photomultiplier tube. The detection unit 18 is constituted by a device such as a photomultiplier tube, a multipixel photon counter (MPPC), a photodiode, and an avalanche photodiode which are capable of performing time-resolved measurement. Here, the detection unit 18 is constituted by a single-channel photomultiplier tube. The detection unit 18 outputs a signal corresponding to the optical response Lr to the data acquisition unit 19.

The data acquisition unit 19 is a part configured to acquire measurement data with respect to the optical pulses L included in the excitation light Le. For example, the data acquisition unit 19 is constituted by an oscilloscope, a PCI board, or the like. The data acquisition unit 19 digitalizes a signal output from the detection unit 18 to generate measurement data and outputs the measurement data to the control unit 4.

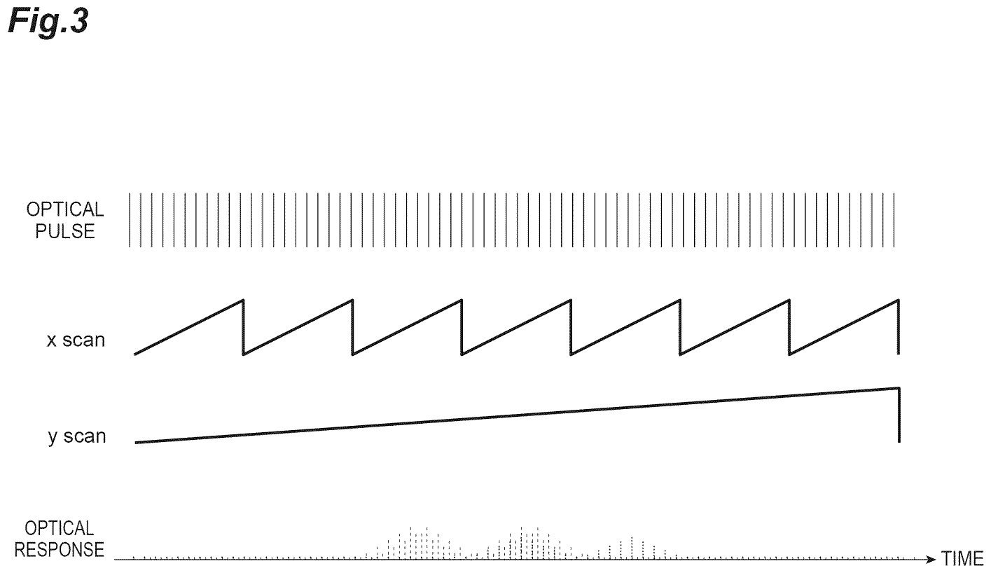

FIG. 3 is a timing chart of optical response acquisition in a typical microscope system. As illustrated in the same drawing, in the typical microscope system, the excitation light is incident to a sample at a predetermined repetition rate. Scanning of the sample with the excitation light in an x-direction and a y-direction is performed at a frequency that is sufficiently slower than the repetition rate of the pulse light beam. Measurement data of the optical response is acquired at each coordinate on an xy plane, and is reconfigured as an observation image.

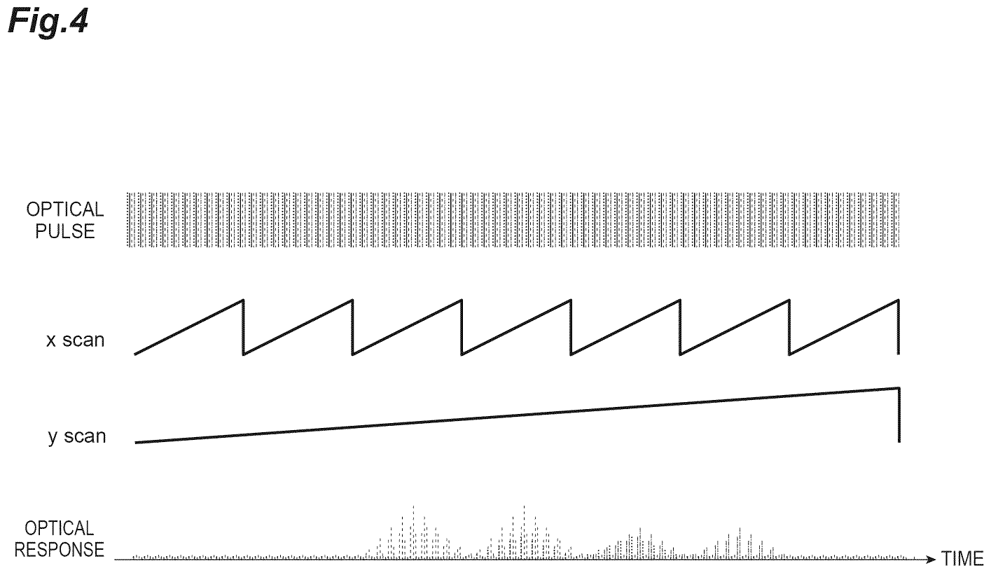

In contrast, FIG. 4 is a timing chart of optical response acquisition in the sample observation device according to this embodiment. As illustrated in the same drawing, in the sample observation device 1, the excitation light Le in which the four optical pulses L with central wavelength of λ₁, λ₂, λ₃, and λ₄ are sequentially arranged at times t₁, t₂, t₃, and t₄ is incident to the sample S. Scanning of the sample S with the excitation light Le in the x-direction and the y-direction is similar as in the case of FIG. 3. On the other hand, the measurement data of the optical responses are time-resolved and acquired at different timings of times t₁, t₂, t₃, and t₄ at each coordinate on the xy plane, and are reconfigured as an observation image.

The control unit 4 is a computer system physically including a memory such as a RAM and a ROM, a processor (operation circuit) such as a CPU, a communication interface, a storage unit such as a hard disk, and a display unit such as a display. Examples of the computer system include a personal computer, a cloud server, a smart device (a smartphone, a tablet terminal, or the like). The control unit 4 may be constituted by a programmable logic controller (PLC), or may be constituted by an integrated circuit such as a field-programmable gate array (FPGA).

The control unit 4 includes a drive control unit 21, a processing unit 22, a storage unit 23, and an image generation unit 24 as functional constituent elements. The drive control unit 21 is a part configured to control an operation of the sample observation device 1. The drive control unit 21 controls respective operations of the laser light source 11, the modulation unit 12, and the scanning unit 15 in response to an input of user's operation by an operation unit (not illustrated).

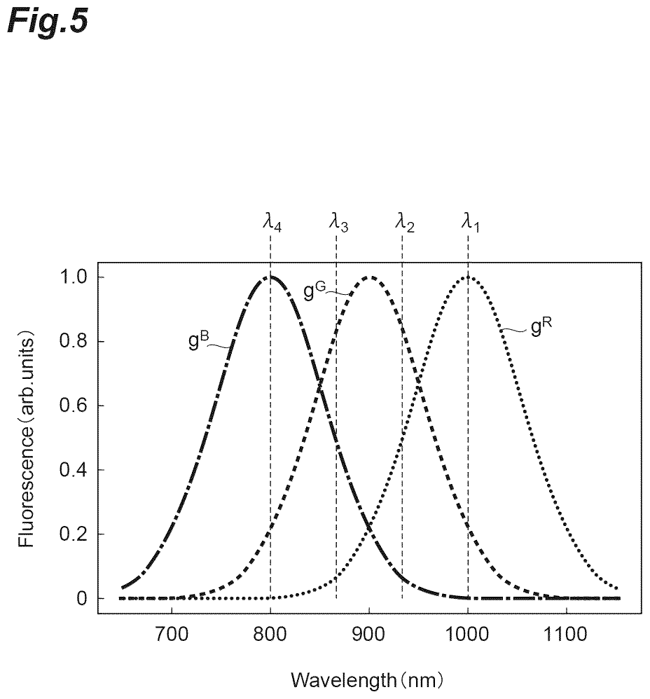

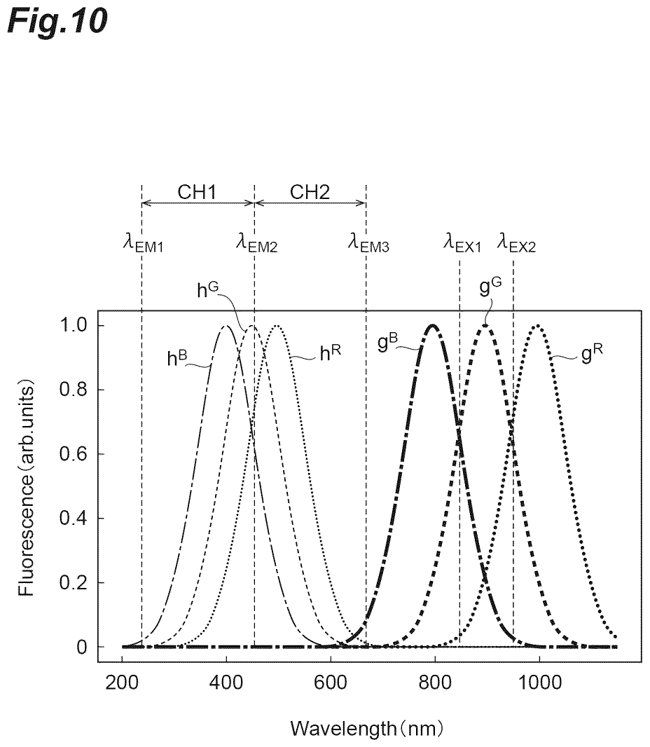

The processing unit 22 is a part configured to perform linear unmixing processing on the measurement data with respect to the optical pulses L on the basis of an excitation spectrum for every target included in the sample S. FIG. 5 is a view illustrating an example of the excitation spectrum. As illustrated in FIG. 5, the excitation spectrum is a spectrum obtained when measuring an intensity of the optical response from each target while changing the wavelength of the excitation light. On the other hand, a spectrum obtained by measuring the optical response from each target with a spectrometer is referred to as an emission spectrum (refer to FIG. 10).

In the example illustrated in FIG. 5, three excitation spectra g^{R}, g^{G}, and g^{B} are illustrated. In this embodiment, data relating to these excitation spectra g^{R}, g^{G}, and g^{B} is retained in the storage unit 23 in advance. The excitation spectra g^{R}, g^{G}, and g^{B} are obtained by preliminary measurement with respect to a region (seed region) where only a specific target in the sample S emits the optical response to the multiple optical pulses L included in the excitation light Le. The excitation spectra may be obtained by measuring the wavelength dependence of the optical responses Lr to the excitation light Le in advance by using an in vitro sample, or by referring to existing data for every target.

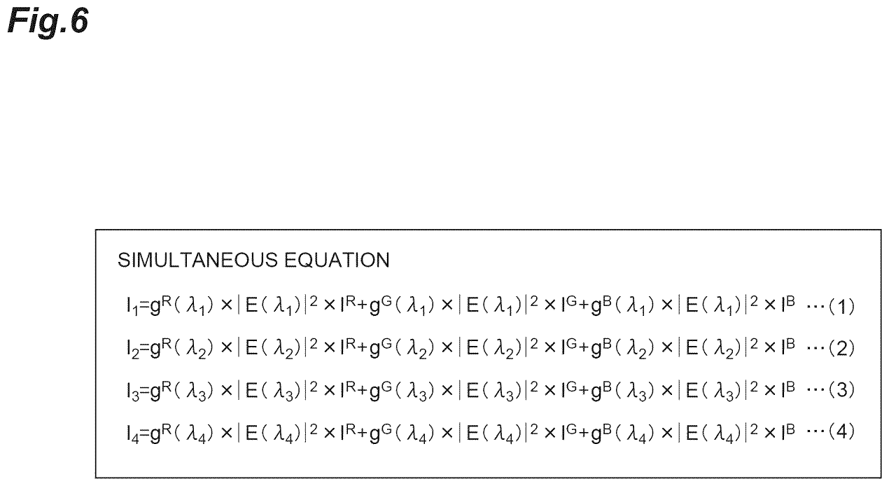

Linear unmixing processing on the measurement data based on the excitation spectrums g^{R}, g^{G}, and g^{B} is performed by using simultaneous equations (1) to (4) shown in FIG. 6. Information that is used in the linear unmixing processing includes the excitation spectra g^{R}, g^{G}, and g^{B} and the wavelengths λ₁, λ₂, λ₃, and λ₄ of the optical pulses L included in the excitation light Le. In the expressions, |Ex(λ)|² is an intensity of each of the optical pulses L included in the excitation light Le. The number of wavelengths of the optical pulses L matches the number of simultaneous equations. The intensity of optical responses I^{R}, I^{G}, and I^{B} associated with the individual targets can be respectively calculated from the time-resolved four optical responses I₁, I₂, I₃, and I₄ by obtaining the solutions of the simultaneous equations (1) to (4) without arranging multiple wavelength separation elements such as dichroic mirrors and photodetectors in the sample observation device 1. The processing unit 22 outputs the measurement data on which the linear unmixing processing has been performed to the image generation unit 24.

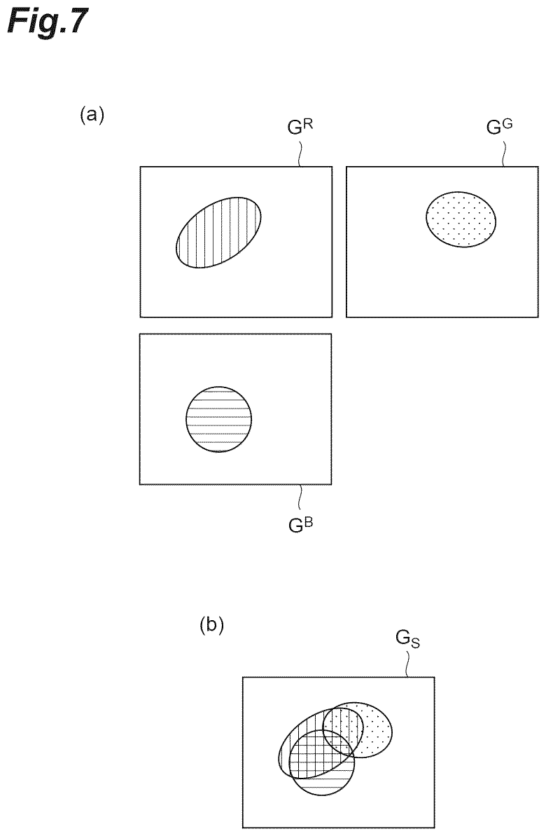

The image generation unit 24 is a part configured to generate the observation image associated with each of the targets obtained as a result of the linear unmixing processing. As illustrated in FIG. 7(a), the image generation unit 24 arranges the values of the optical responses I^{R}, I^{G}, and I^{B}, which are associated with the individual targets and are obtained as a result of the linear unmixing processing, the xy plane to generate observation images G^{R}, G^{G}, and G^{B} associated with each of the targets. In this embodiment, as illustrated in FIG. 7(b), the image generation unit 24 generates a superimposed image Gs in which the observation images G^{R}, G^{G}, and G^{B} associated with each target are superimposed on each other. The image generation unit 24 outputs all or a part of the generated observation images G^{R}, G^{G}, and G^{B}, and the superimposed image Gs to the display unit 25. In the display unit 25, the observation results of the sample S by all or a part of the observation modalities are displayed.

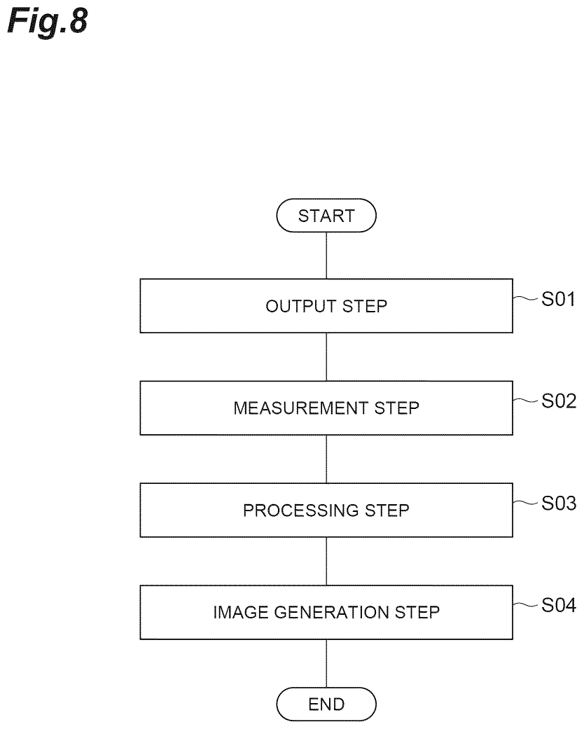

FIG. 8 is a flowchart showing an embodiment of a sample observation method. As shown in the same drawing, the sample observation method includes an output step (step S01), a measurement step (step S02), a processing step (step S03), and an image generation step (step S04).

In the output step S01, the center wavelengths of the optical pulses L emitted from a single light source are modulated in the time domain, and the pulse train Lc in which the multiple optical pulses L with different center wavelengths are arranged at predetermined time intervals are output as the excitation light Le. Here, the ultrashort optical pulses from the laser light source 11 operating at a predetermined repetition rate is modulated by using soliton self-frequency shift (refer to FIG. 2). In the soliton self-frequency shift, the center wavelength of the optical pulse is changed with an input intensity. According to this, the pulse train Lc in which the four optical pulses L with center wavelengths of λ₁, λ₂, λ₃, and λ₄ are sequentially arranged at times t₁, t₂, t₃, and t₄ is output as the excitation light Le.

In the measurement step S02, time-resolved measurement is performed for distinguishing the optical responses I₁, I₂, I₃, and I₄ to the optical pulses L with the different center wavelength included in the excitation light Le while scanning the sample S, and measurement data with respect to the optical pulses L is acquired. In the subsequent processing step S03, linear unmixing processing is performed on the measurement data with respect to the optical pulses L on the basis of an excitation spectrum for every target included in the sample S. In the processing step S03, for example, an excitation spectrum of a region in the sample S where only a specific target emits the optical responses to the optical pulses L included in the pulse train is retained in advance, and linear unmixing processing is performed on the measurement data with respect to the optical pulses L on the basis of the excitation spectrum. According to this, the optical responses I^{R}, I^{G}, and I^{B} associated with the individual targets are separated from the measurement data of the optical responses I₁, I₂, I₃, and I₄.

In the image generation step S04, values of the optical responses I^{R}, I^{G}, and I^{B} which are associated with the individual targets and are obtained as a result of the linear unmixing processing, are arranged on a two-dimensional plane to generate the observation images G^{R}, G^{G}, and G^{B} relating to the individual targets. In addition, in the image generation step S04, the superimposed image Gs in which the observation images G^{R}, G^{G}, and G^{B} associated with the individual targets are superimposed on each other is generated. Then, all or a part of the generated images G^{R}, G^{G}, and G^{B}, and the superimposed image Gs is output to the display unit 25, and observation on the targets of the sample S is performed.

As described above, in the sample observation device 1, the pulse train Lc in which the multiple optical pulses L with different center wavelengths are arranged at predetermined time intervals is formed. When applying each of the center wavelengths of the multiple optical pulses L to each observation modality, it is not necessary to arrange multiple light sources corresponding to the number of observation modalities. In addition, in the sample observation device 1, time-resolved measurement is performed on light that is transmitted from the sample S and corresponds to irradiation with the optical pulses L, and linear unmixing processing is performed on the measurement data with respect to the optical pulses L on the basis of the excitation spectrum for every target included in the sample S. According to this, it is not necessary to arrange multiple wavelength separation elements and photodetectors which correspond to the number of observation modalities. In addition, since the linear unmixing processing is used, cross-talks between the obtained observation images G^{R}, G^{G}, and G^{B} associated with the individual targets can be avoided. Accordingly, in the sample observation device 1, multimodal observation of a sample S can be performed with a simple optical system.

In the sample observation device 1, in a case where the repetition rate of the optical pulses L in the excitation light Le is set to 80 MHz, and the typical lifetime of the optical responses Lr emitted from the sample S is considered as approximately 3 ns, observation on the sample S can be performed by four kinds of observation modalities by using the optical pulses L with center wavelengths of λ₁, λ₂, λ₃, and λ₄. In addition, in the sample observation device 1, since the optical responses I^{R}, I^{G}, and I^{B} from individual targets are subjected to the linear unmixing processing, an observation target is not limited. This becomes an essential advantage in a label-free microscope system in which an emission spectrum of a target cannot be controlled by staining.

The linear unmixing processing is relatively simple, and the observation images G^{R}, G^{G}, and G^{B}, and the superimposed image Gs can be obtained approximately in real time in correspondence with acquisition of the measurement data. In the multimodal observation, real-time measurement is important. In an aspect in which an excitation wavelength is switched for every observation modality, for example, in a medical field, it is difficult to observe an event such as extravasation of leucocytes in blood vessel branches adjacent to tumors. Such event can only be grasped by performing real-time observation on a sample with multiple observation modalities, and this shows high usefulness of the sample observation device 1.

In this embodiment, the light source unit 2 generates the pulse train Lc by temporally modulating the center wavelengths of the optical pulses L generated from a single laser light source 11. According to this, the optical system can be further simplified. In addition, in this embodiment, the pulse train Lc is generated by using the soliton self-frequency shift in which an output wavelength depends on an input intensity. According to this method, for example, time modulation for every wavelength of the optical pulses L can be simply performed by using a fiber laser. Accordingly, simplification of the device is accomplished.

In this embodiment, an excitation spectrum of a region in the sample S where only a specific target emits the multiple optical pulses L with different wavelengths included in the pulse train Lc is retained in advance, and the linear unmixing processing is performed on measurement data with respect to the optical pulses L on the basis of the excitation spectrum. Since the excitation spectrum is exactly same as that of the actual sample S, the accuracy of the linear unmixing processing can be sufficiently secured. Accordingly, the cross-talks between the obtained measurement data can be more preferably avoided.

In this embodiment, the observation images G^{R}, G^{G}, and G^{B} associated with the individual targets are generated by performing the linear unmixing processing on the measurement data. According to this, the observation images G^{R}, G^{G}, and G^{B} associated with the respective observation modalities can be obtained the suppressed cross-talks. In addition, in this embodiment, the superimposed image Gs in which the observation images G^{R}, G^{G}, and G^{B} are superimposed on each other is generated. According to this, observation results associated with the respective observation modalities are collected to one image, and thus convenience when analyzing the observation results can be improved. In addition, it is also possible to analyze the events based on the simultaneous observation of multiple modalities.

The present disclosure is not limited to the above-described embodiment. For example, in the above-described embodiment, the detection unit 18 is constituted by a single-channel detector, but the detection unit 18 may be constituted by a multi-channel detector instead of the single-channel detector. Examples of the detector include a multi-channel photomultiplier tube, and the like. According to this configuration, even in a case where the number of the wavelengths of the optical pulses L included in the excitation light Le is smaller than the number of the targets of the sample S, the solution of the simultaneous equations used in the linear unmixing processing can be obtained.

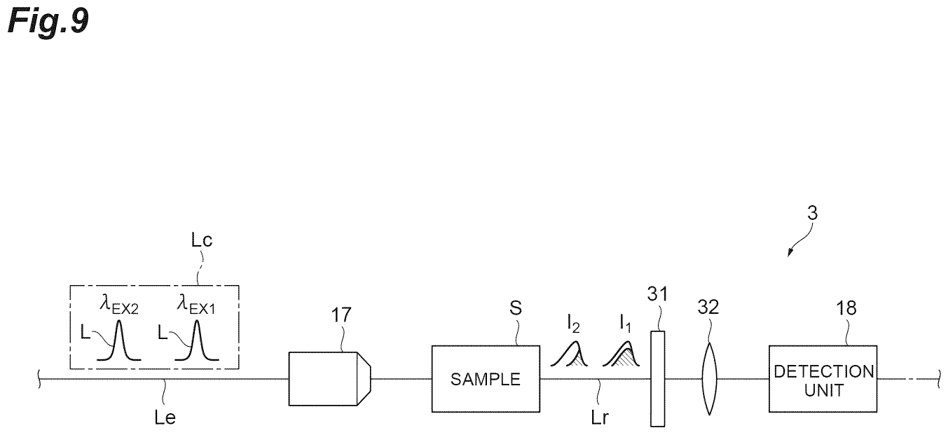

When employing this configuration, for example, as illustrated in FIG. 9, a pulse train Lc in which two optical pulses L with the center wavelengths of λ_{EX1} and λ_{EX2} are sequentially arranged is generated as the excitation light Le. The two optical responses I₁ and I₂ are generated by the irradiation with the two optical pulses L. In addition, a diffraction grating 31 and a lens 32 are placed on an optical path of the optical responses Lr between the sample S and the detection unit 18 to provide the measurement unit 3 with a spectroscopic function. Due to addition of the diffraction grating 31, a propagation direction can be changed depending on the wavelength of the optical responses Lr from the sample S. Accordingly, in a case where the detection unit 18 is the multi-channel photomultiplier tube, the different wavelength bands can be simultaneously detected with its multiple channels.

In linear unmixing processing on the measurement data of the optical responses Lr which is acquired by the above-described configuration, as illustrated in FIG. 10, an emission spectrum is used in addition to the excitation spectrum. In an example illustrated in FIG. 10, three emission spectra of h^{R}, h^{G}, and h^{B} are illustrated in combination with three excitation spectrums g^{R}, g^{G}, and g^{B}. CH1 and CH2 are two channels of the photomultiplier tube. A short-wavelength band of the optical responses Lr is detected by CH1 and a long-wavelength band of the optical responses Lr is detected by CH2. The wavelength range measured by CH1 is expressed as [λ_{EM1}, λ_{EM2}], and the wavelength range measured by CH2 is expressed as [λ_{EM2}, λ_{EM3}]. Values of λ_{EM1}, λ_{EM2}, and λ_{EM3} can be adjusted by a grating pitch of the diffraction grating 31, a focal distance of the lens 32, an optical path length from the diffraction grating 31 to the detection unit 18, and the like.

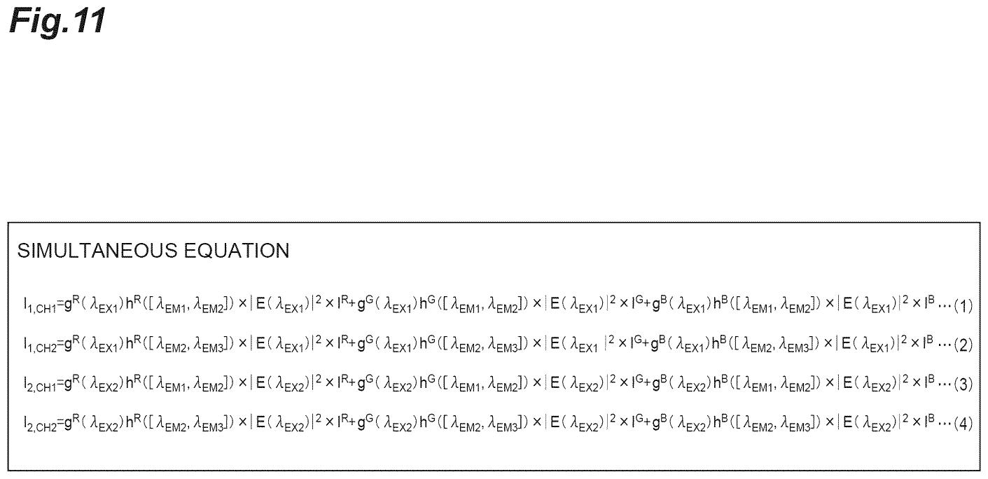

Linear unmixing processing on the measurement data based on the excitation spectra g^{R}, g^{G}, and g^{B}, and the emission spectra of h^{R}, h^{G}, and h_{B} is performed by using simultaneous equations (1) to (4) shown in FIG. 11. Information that is used in the linear unmixing processing includes the excitation spectra g^{R}, g^{G}, and g^{B}, the emission spectra of h^{R}, h^{G}, and h^{B}, and wavelengths λ_{EX1} and λ_{EX2} of the optical pulses L included in the excitation light Le. These parameters are defined for each of the channels CH1 and CH2. h[λ_{EM1}, λ_{EM2}] is an integrated value of light-emission spectrums in the section [λ_{EM1}, λ_{EM2}], and h[λ_{EM2}, λ_{EM3}] is an integrated value of the emission spectra in the section [λ_{EM2}, λ_{EM3}]. The integrated values are respectively defined for the individual targets. In the expressions, |E(λ_{EX1})|² and |E(λ_{EX2})|² are intensities of the optical pulses L included in the excitation light Le.

In this aspect, the number of wavelengths of the optical pulses L is two, but since the number of channels of the detection unit 18 is two, and thus the product of the number of the wavelengths of the optical pulses L and the number of channels of the detection unit 18 matches the number of simultaneous equations. Accordingly, the solution of the simultaneous equations (1) to (4) shown in FIG. 11 can be obtained, and the optical responses I^{R}, I^{G}, and I^{B} associated with the individual targets can be respectively calculated from the four optical responses I_{2,CH1}, and I_{2,CH2}.

In addition, for example, the above-described embodiment exemplifies the light source unit 2 that outputs the pulse train Lc in which the multiple optical pulses L with different center wavelengths are arranged at predetermined time intervals as the excitation light Le by temporally modulating the center wavelengths of the optical pulses L emitted from the single laser light source 1, but the light source unit 2 may employ an aspect in which the similar excitation light Le is output by using multiple laser light sources. In this case, for example, the light source unit 2 may have a configuration in which multiple laser light sources with different wavelengths and wavelength separation elements such as dichroic mirrors are combined to generate optical pulses from each laser light source at predetermined time intervals.

### REFERENCE SIGNS LIST

1: sample observation device, 2: light source unit, 3: measurement unit, 11: laser light source (single light source), 18: detection unit, 22: processing unit, 24: image generation unit, L: pulse light beam, Lc: pulse train, Le: optical response, Lr: optical response (light emitted from sample), G^{R}, G^{G}, G^{B}: observation image, Gs: superimposed image, S: sample.

1. A sample observation device, comprising:
a light source configured to output a pulse train in which multiple optical pulses with different center wavelengths are arranged at predetermined time intervals as excitation light;
a measurement unit configured to perform time-resolved measurement for distinguishing optical responses to the optical pulses with different center wavelengths included in the pulse train while scanning the sample, and to acquire measurement data with respect to the optical pulses; and
a processor configured to perform linear unmixing processing on the measurement data with respect to the optical pulses on the basis of an excitation spectrum for every target included in the sample.

2. The sample observation device according to claim 1,
wherein the light source generates the pulse train by temporally modulating the center wavelengths of the optical pulses generated from a single light source.

3. The sample observation device according to claim 1,
wherein the light source generates the pulse train by using soliton self-frequency shift in which an output wavelength depends on an input intensity.

4. The sample observation device according to claim 1,
wherein the processor retains an excitation spectrum of a region in the sample where only a specific target emits light with respect to the multiple optical pulses included in the pulse train in advance, and performs linear unmixing processing on measurement data with respect to the optical pulses on the basis of the excitation spectrum.

5. The sample observation device according to claim 1, further comprising:
an image generator configured to generate an observation image relating to a specific target on the basis of the measurement data on which the linear unmixing processing has been performed.

6. The sample observation device according to claim 5,
wherein the image generator generates a superimposed image in which observation images relating to the specific target are superimposed on each other.

7. The sample observation device according to claim 1,
wherein the measurement unit includes a multi-channel detection unit configured to perform time-resolved measurement on the optical response from the sample.

8. A sample observation method, comprising:
outputting a pulse train in which multiple optical pulses with different center wavelengths are arranged at predetermined time intervals as excitation light;
measuring time-resolved measurement for distinguishing optical responses to the optical pulses with different center wavelengths included in the pulse train while scanning the sample with the excitation light, and acquiring measurement data with respect to the optical pulses; and
processing linear unmixing processing on the measurement data with respect to the optical pulses on the basis of an excitation spectrum for every target included in the sample.

9. The sample observation method according to claim 8,
wherein in the outputting, the pulse train is generated by temporally modulating the center wavelengths of the optical pulses generated from a single light source.

10. The sample observation method according to claim 8,
wherein in the outputting, the pulse train is generated by using soliton self-frequency shift in which an output wavelength depends on an input intensity.

11. The sample observation method according to claim 8,
wherein in the processing, an excitation spectrum of a region in the sample where only a specific target emits light with respect to the multiple optical pulses included in the pulse train is retained in advance, and linear unmixing processing is performed on measurement data with respect to the optical pulses on the basis of the excitation spectrum.

12. The sample observation method according to claim 8, further comprising:
generating an observation image relating to a specific target on the basis of the measurement data on which the linear unmixing processing has been performed.

13. The sample observation method according to claim 12,
wherein in the generating, a superimposed image in which observation images relating to the specific target are superimposed on each other is generated.

14. The sample observation method according to claim 8,
wherein in the measuring, time-resolved measurement is performed on the optical response from the sample by multi-channel detection.
